(19) United States
(12) Patent Application Publication
(10) Pub. No.: US 2025/0389493 A1
(43) Pub. Date: Dec. 25, 2025

(54) THERMAL ENERGY STORAGE SYSTEM

(71) Applicant: CARTESIAN AS, Trondheim (NO)

(72) Inventor: Alexis SEVAULT, Trondheim (NO)

(21) Appl. No.: 18/879,830

(22) PCT Filed: May 31, 2023
(86) PCT No.: PCT/NO2023/050125

§ 371 Date: Dec. 30, 2024

(30) Foreign Application Priority Data
Jun. 30, 2022 (NO) 20220752

(51) Int. Cl. F28D 20/02; F28D 20/00; F28F 1/02

(52) U.S. Cl. CPC F28D 20/021; F28F 1/022; F28D 2020/0078

(57) ABSTRACT

The invention relates to a thermal energy storage system which includes a container with a phase change material (PCM) and a heat exchange coil interacting with the PCM. The coil is easy to produce and assemble within said system. The coil includes a plurality of internal channels for transporting a heat exchange fluid and provide a large surface area though which heat is transferred. The invention also relates to a method of manufacturing the coil by means of extrusion, and to a method of assembling said system.

### FIELD OF THE INVENTION

The invention relates to a thermal energy storage system and a method of manufacturing said system.

### BACKGROUND

About half of the energy consumption for industry and buildings is in the form of thermal energy (heat or cold). The process industry, food & beverages industry and building owners typically face high daily fluctuations of energy demands for heating and/or cooling. As a consequence of this oversized heating/cooling systems are required for handling peak demands with a high dynamic range of operation to face the fluctuations. Also, Industries may have to limit production capacity to avoid energy blackouts if the instant energy demand reaches the maximum capacity of the power grid or the district heating grid. Furthermore, high peak loads lead to significantly increased energy bills since prices are correlated to power demands and not just total energy consumption.

Implementing thermal energy storage (TES) may solve the peak energy demand, particularly for thermal energy. According to the International Energy Agency, TES is the key to a more flexible, reliable and sustainable management of thermal and electric energy demand in the industry. Integrated TES units used as thermal batteries are an effective solution to decouple heat (or cold) production from utilization and offers dual benefits: (1) better management of energy utilization by supplying extra thermal energy during the peak demand hours; (2) cost effectiveness whenever there is a mismatch between energy production and demand.

A TES unit forms a complex structure with many internal components and may be costly to produce and assemble. An object of this invention is to provide a simple and effective TES system which comprises a reduced number of internal components. Furthermore, the invention provides a simple, strong and effective heat exchange coil which is easy to produce and mount within the TES system, only requiring a limited amount of welding points, which increases the heat exchanger's lifetime and reduces maintenance costs. A limited amount of welding points reduces the risk of leakage. If the heat exchange fluid is mixed with the PCM fluid, the PCM becomes contaminated and therefore less effective. Also, a leak may generate an acidic and highly corrosive composition which may damage internal components of a TES-system.

It is also an object of the invention to provide a TES-system which can easily be upscaled, by means of extrusion, without requiring significantly more welding points. By extruding the heat exchanger coil of the invention, it is easy to adjust scaling parameters such as profile parameters, length and width. Also, the invention is easy to assemble, and provides a light-weight structure which is beneficial for light-weight demanding environments such as freight containers and ships.

In addition, using aluminum instead of alternative heat exchanger materials, such as stainless steel, will yield a lower CO₂ footprint for the overall heat exchanger thanks to available aluminum produced in CO₂-free processes. Aluminum will also yield higher heat transfer performance, thanks its higher thermal conductivity.

U.S. Pat. No. 6,101,821A describes an ice-on-coil (IOC) thermal storage coil system and method that uses “deep-tank” technology. The key features include a serpentine tubular coil with a vertical height greater than its horizontal width, ensuring efficient ice cylinder formation in a thermal storage tank. Additionally, the supply and return headers for the refrigerant are located at the upper end of the coil, making them easily visible and accessible for maintenance, assembly, leak-checking, or repair. In some embodiments, the coil tubes are not horizontal but instead use vertical or sloped tubes to aid in air removal during filling with the coolant mixture.

CN107860255A pertains to a heat storage device and an associated air conditioner. The heat storage device consists of a body module and heaters, with the body module containing a phase change heat storage material. The heaters are responsible for heating the phase change heat storage material.

### SUMMARY OF THE INVENTION

The invention relates to a thermal energy storage system having a container forming an inner volume, a hollow heat exchange coil located inside the container, wherein the heat exchange coil is configured to internally transport a coil fluid, an inlet fixed to a wall of the container, wherein the inlet being in fluid connection with the coil and an outlet fixed to a wall of the container, the outlet being in fluid connection with the coil. The inner volume is, during operation, at least partly filled with a phase change material surrounding at least a part of the coil. The coil includes a plurality of internal channels for transporting the coil fluid forming a thickness, and the coil has an elongated cross-section with a height and a width.

The invention further relates to said thermal energy storage system, wherein the coil is made of aluminium or an aluminium alloy.

The invention further relates to said thermal energy storage system, wherein the coil is U-shaped with one curved section or wherein the coil is serpentine-shaped with a plurality of curved sections, and wherein each curved section has a radius of curvature.

The invention further relates to said thermal energy storage system, wherein the inlet and the outlet are fixed to the same wall of the container, or wherein the inlet and the outlet are fixed to separate walls of the container.

The invention further relates to said thermal energy storage system, wherein the coil fluid is a gas such as air, steam, CO2, butane, propane, ammonia or a combination of the former.

The invention further relates to said thermal energy storage system, wherein the coil fluid is a liquid such as water, glycol, CO2, ammonia, butane, oil, propane or a combination of the former.

The invention further relates to said thermal energy storage system, wherein phase change material is one of, or a combination of water, hydrated salts, organic compounds, sugar-alcohol, paraffine, esters, high-density polyethylene, and eutectic mixtures.

The invention further relates to said thermal energy storage system, wherein each internal channel has a round, elliptical, rectangular or square cross-section.

The invention further relates to said thermal energy storage system, wherein the coil has a width to height ratio between 3:1 and 2000:1.

The invention further relates to said thermal energy storage system, wherein the coil has a height of 1-4 mm and a width of 10-2000 mm.

The invention further relates to said thermal energy storage system, wherein the radius of curvature is 5-25 mm, the width is 10-2000 mm and the height is 1-4 mm.

The invention further relates to said thermal energy storage system, wherein the coil has a height to thickness ratio between 2:1 and 20:1.

The invention further relates to said thermal energy storage system, wherein the ratio between a summarized cross-sectional area of the internal channels (A2) and a cross-sectional coil area and is between 1:4 and 4:1.

The invention also relates to a method of manufacturing the hollow heat exchange coil according to any of the preceding claims by means of extrusion.

The invention also relates to a said method, wherein the coil is extruded in aluminium or an aluminium alloy.

The invention also relates to a method of assembling a thermal energy storage system according to any of the preceding claims, comprising the steps of:
providing an inlet and fixing the inlet to a wall of the container;
providing an outlet and fixing the outlet to a wall of the container;
introducing the coil inside the container; and
fixing the coil at one end to the inlet and fixing the coil at the opposite end to the outlet.

### LIST OF FIGURES

FIG. 1 is a side view of the invention according to an embodiment;

FIG. 2 is a side view of the invention according to an embodiment;

FIG. 3 is a side view of the invention according to an embodiment;

FIG. 4 is a cross-sectional profile view of the heat exchange coil according to an embodiment;

FIG. 5 is a cross-sectional profile view of the heat exchange coil according to an embodiment.

### DETAILED DESCRIPTION OF THE INVENTION

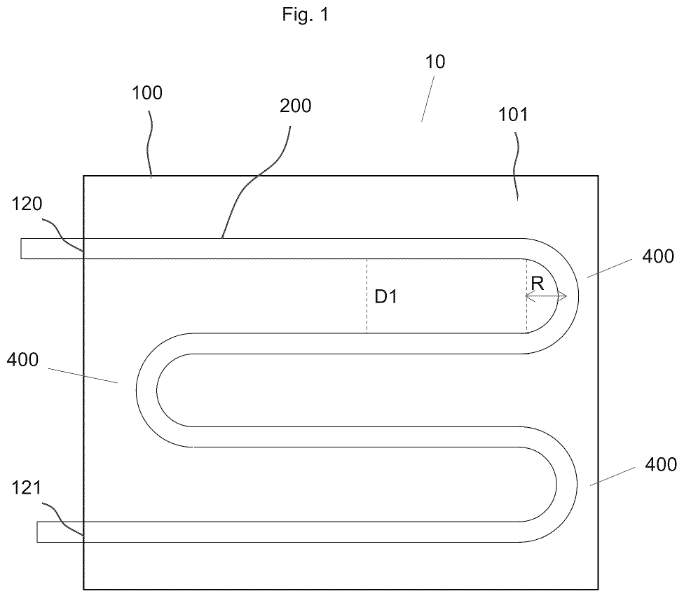

FIG. 1 is a side view of the invention according to an embodiment. FIG. 1 shows a thermal energy storage (TES) system 10 having a container 100 that forms an inner volume 101. The TES system 10 further includes at least one heat exchange coil 200 located within the inner volume 101. Preferably the coil 200 is made of aluminium or aluminium alloy.

The container 100 is at least partly filled with PCM (Phase Change Material) 300 surrounding at least parts of the heat exchange coil 200. Ideally the PCM 300 is one of, or a combination of water, hydrated salts, organic compounds, sugar-alcohol, paraffine, esters, high-density polyethylene, and eutectic mixtures. Preferably the container is filled with PCM 300 so that the coil 200 is completely submerged in PCM 300.

The heat exchange coil 200 is connected at one end to an inlet 120 which is fixed to a wall of the container, and at another end to an outlet 121 which is also fixed to a wall of the container. The inlet 120 and outlet 121 may be fixed to, or form part of, at least one distribution header (not shown).

In FIG. 1, the inlet 120 and outlet 121 are fixed to the same wall, but different variations of this are shown in the other figures. The heat exchange coil 200 is a hollow element having at least one internal transport channel 220 for transporting a coil fluid 230 (se FIG. 4). The channel or channels run like bores internally so that the coil 200 can transport the fluid 230 internally from inlet 120 to outlet 121 while allowing conductive heat exchange between the fluid 230 and a PCM 300. The coil 200 is configured to provide a large surface area through which the coil fluid 230 interacts with the PCM 300 via the coil 200 material.

The inlet 120 and outlet 121 is in fluid connection with external sources and components during operation which includes a pump to pressurize and thereby transport the fluid through the coil 200.

The coil 200 may be serpentine-shaped or S-shaped with a plurality of curved sections 400 wherein each curved section 400 has a radius of curvature R. An advantage of such shape is that the TES system 10 may include only a single, or at least very few, internal heat exchange component(s) covering a large portion of the inner volume 101 which is/are easy to produce and assemble.

The heat exchange coil 200 may easily be extruded throughout its length providing a simple and cost-efficient manufacturing process.

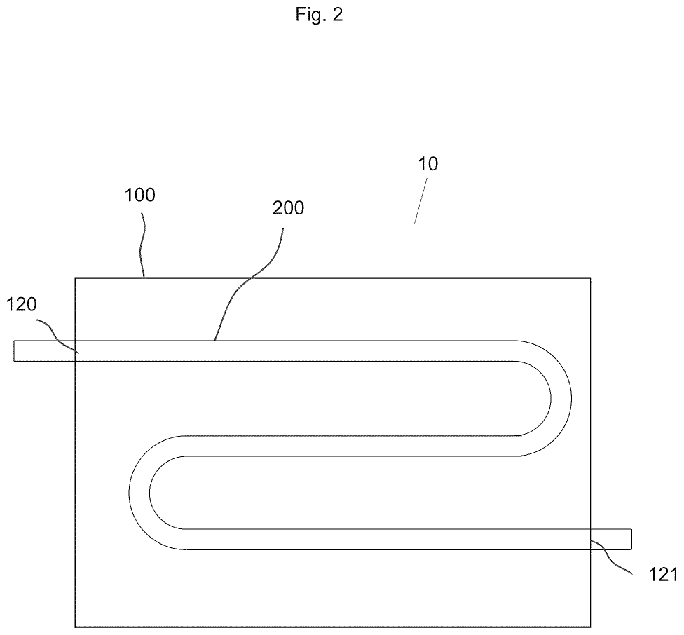

FIG. 2 is a side view of the invention according to an embodiment. FIG. 2 shows an alternative configuration of the embodiment shown in FIG. 1. In FIG. 2 the coil 200 is S-shaped and the inlet 120 and the outlet are fitted to separate walls of the container 100.

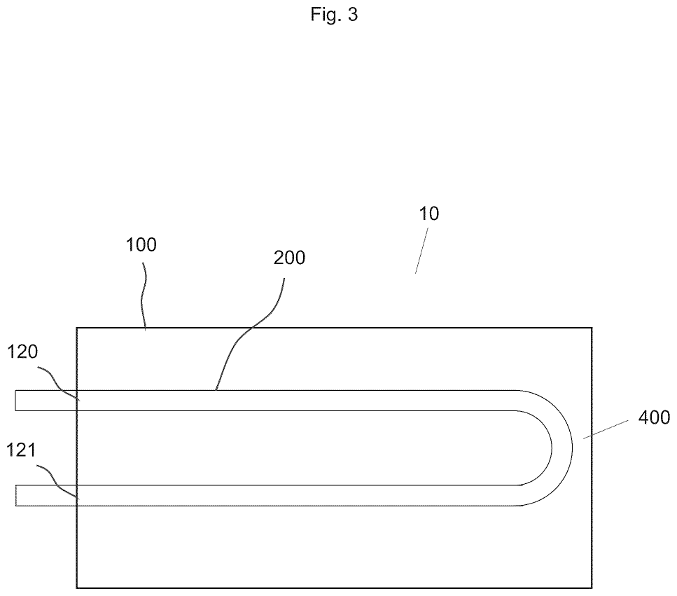

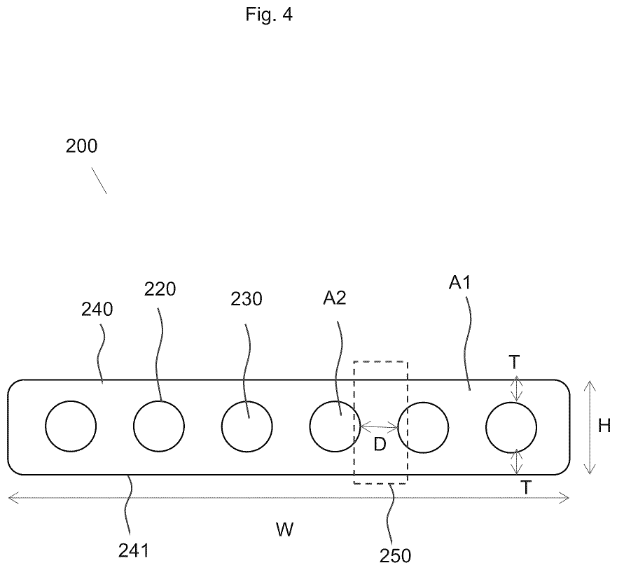

FIG. 3 is a side view of the invention according to an embodiment. FIG. 2 shows an alternative configuration of the embodiment shown in FIG. 1. In FIG. 2 the coil 200 is U-shaped and the inlet 120 and the outlet are fitted to the same wall of the container 100.

FIG. 4 is a cross-sectional profile view of the heat exchange coil 200 according to an embodiment. The coil 200 has a height H and a width W wherein W is significantly larger than H. The width W to height H ratio may be between 3:1 and 2000:1, ideally between 5:1 and 50:1. The height H may be 1-4 mm and the width W may be 10-2000 mm.

FIG. 4 shows how the coil 200 may include an array of channels 220 which form internal bores running throughout the length of the coil 200 (not shown) for transporting a heat transfer fluid 230. The coil 200 may also include a single channel having an elongated cross-section. The coil 200 may e.g. include 2-2000 channels. Because of the channels 220, the profile obtains a thickness parameter T which is substantially equal above and below each channel 220. The thickness parameter T is the distance between the upper or lower part of the channel 220 to the perimeter of the coil profile. The thickness parameter T signifies a thermal conducting distance and is also indicative of the rigidness of the coil 200. The thickness T is ideally as small as possible to facilitate heat transfer, but sufficiently thick to endure the internal pressure and bending moment and strain.

The at least one channel 220 is adapted to transport a heat exchange coil fluid 230 to and from an external source. The coil fluid 230 may be a gas such as air, CO₂, butane, propane or a combination of the former. The coil fluid 230 may also be a liquid such as water, glycol, CO₂, ammonia, butane, oil, propane or a combination of the former.

The channels 220 are depicted as circular in FIG. 4 although they may de shaped differently. They may also be shaped elliptically. In the embodiment shown in FIG. 4 each channel has a substantially equal diameter, and they are aligned adjacently in a row having a substantially equal distance from each other, although the distance between the channels 220 may vary. In FIG. 4 the channels 220 are placed perfectly in line where the centre of each channel is aligned along the same horizontal axis (not shown). The coil 200 may be formed of a lightweight, strong and heat conductive material such as aluminium or aluminium alloy.

The geometry of the coil 200 profile form intermediate sections 250 having a width D and a height H between the channels 220. The intermediate sections act as support columns and prevents the internal bore(s) from collapsing when extruding and bending the coil 200 to form the curved sections 400. This is advantageous in that the channels maintain their cross-sectional area A2 throughout the curved sections 400.

The number of channels 220 will depend on the profile width W and height H. An object of the invention is to provide an internal flow area as large as possible while at the same time providing a sufficiently thick profile to support the pressure of the fluid circulating in the coil 200.

In an embodiment the coil 200 comprises merely a single rectangular internal channel 220 which maximises the internal flow area A2.

The coil 200 provides an upper surface 240 and a lower surface 241 each having a width W and a length L (not shown) which is equal to the total length of the coil 200. The upper surface 240, the lower surface 241 or the side surfaces may include an engraved pattern or comprise grooves. The coil 200 profile acts as a series of conjoint tubular coils providing instead a single coil with a large upper surface 240 and a large lower surface 241 for heat exchange opposed to having a series of tubular coils which has to be individually manufactured and individually assembled.

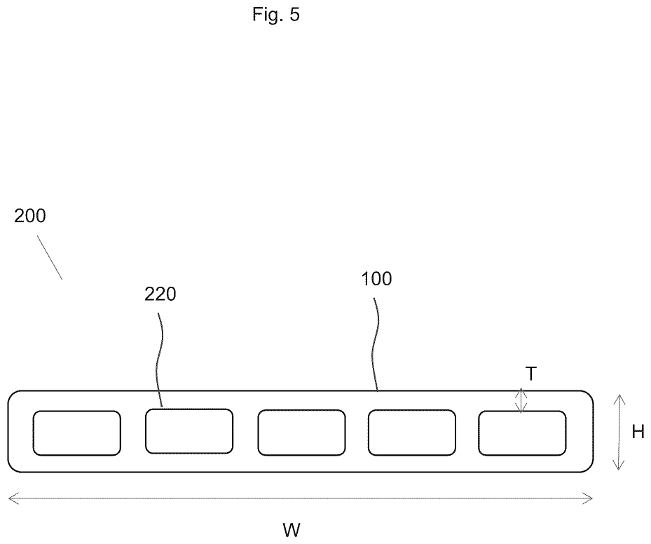

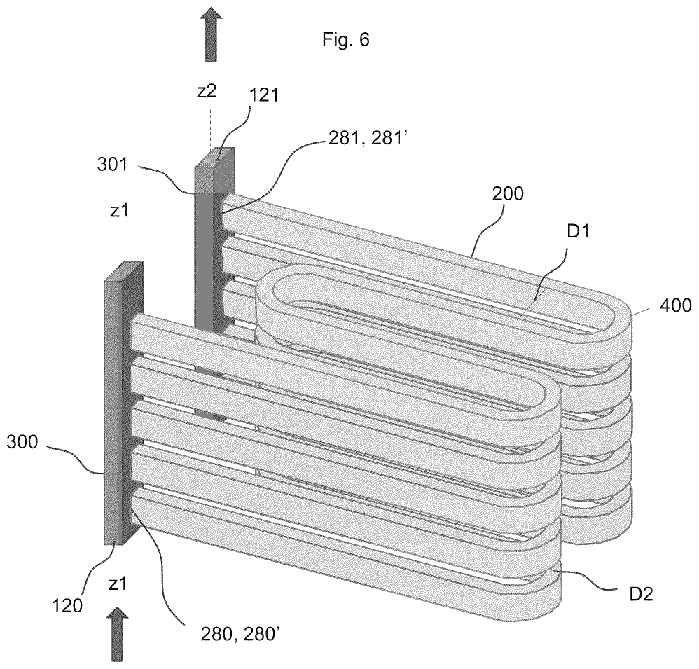

FIG. 5 is a cross-sectional profile view of the heat exchange coil 200 according to an embodiment. The embodiment of FIG. 5 is equal to the embodiment of FIG. 4 except the channels 220 having a substantially rectangular profile. The channels 220 may also have square profiles. Square or rectangular profiles may increase the flow area within each coil 200, compared to circular or elliptical profiles.

FIG. 6 is a perspective view of a heat exchange coil 200 according to the invention. The embodiment of FIG. 6 includes a plurality of heat exchange coils 200 (as previously described), however, the invention may also include merely a single heat exchange coil 200 preferably with a wide and elongated profile. Thus, the invention may include at least one heat exchange coil 200. In FIG. 6 the heat exchange coil 200 is connected at a first end 280 to a port 280′ (not shown) located on a first header 300. Headers may also be referred to as a manifolds. The heat exchange coil 200 is further connected at a second end 281 to a port 281′ (not shown) located on a second header 301. The first header 300 includes a fluid inlet 120 in fluid communication with each port 280′ of the first header 300. The second header 301 includes a fluid outlet 121 in fluid communication with each port 281′ of the second header 301. The heat exchange coils 200 extend substantially perpendicular to the headers 300, 301.

The assembly of FIG. 6 constitutes a fluid transport system ready for deployment in a container 100 (see FIG. 1) of the invention. Each heat exchange coil 200 may be extruded in metal and later connected to its respective ports on the first and second headers 300, 301 by means e.g. of brazing or welding. Once the assembly of FIG. 6 is placed inside a container 100 of the invention, the headers 300, 301 are fixed and connected the same or separate walls (not shown) of the container 100 so that a coil fluid 230 from an external source may be passed through a container wall, through the first header 300, further through each heat exchange coil 200, further through the second header 301, through a container wall and out of the container 100. Typically, the inlet and outlet 120, 121 are connected to the same wall or the opposite walls of the container 100 to improve fluid flow through the coils 200.

The elongated shape of the coils 200 is one of the key features of this invention. This shape is particularly advantageous because it provides a flat surface onto which sensors or connection means can be easily mounted. This surface is much more accessible and user-friendly than the cylindrical profile of traditional tubular coils.

In practical terms, this means that it will be much easier and quicker to install sensors or connection means onto the coils 200 compared to previous designs. For instance, with an ultrasound sensor located within the container, the sensor can be fixed simply onto the flat surface of a coil 200 without any undue complications. This allows for effective and efficient measurement of the state of charge of the PCM material in the container.

Overall, the elongated profile of the coils 200 is a key innovation of this patent application that facilitates the installation and use of sensors or connection means. By making the container more accessible and easier to work with, the invention promises to enhance the functionality and usability of PCM materials, providing important benefits in a range of practical applications.

In FIG. 6, the assembly is oriented so that the headers align vertically, i.e. upright. In this orientation the headers 300, 301 would typically be fixed and connected to the bottom container wall (not shown) and/or the top container wall (not shown). The assembly of FIG. 6 may also be oriented so that the headers 300, 301 extend horizontally. In this orientation the headers 300, 301 would be fixed and connected to a first side wall of the container 100 (not shown) and/or another side wall of the container 100 (not shown). By having the headers 300, 301 vertically aligned, the coils 200 are horizontally aligned. By having the headers 300, 301 horizontally aligned, the coils 200 are vertically aligned. By having the coils 200 vertically aligned, less moment forces are imposed on the connection points between the headers 300, 301 and the coils 200 than when the coils 200 are horizontally aligned, which is advantageous. When the coils are oriented horizontally, auxiliary support structures may be provided to reduce said moment forces, e.g. by connecting the coils 200 at different locations to a nearby container wall (not shown). Alternatively, support columns fixed to the bottom wall of the container may be connected to each coil 200.

The number of coils 200 determine the number of welds or connection points to the headers 300, 301. Therefore, the invention may include only a single or only few coils 200 with a wide profile (see FIG. 4).

The assembly of FIG. 6 provides a simplified and modular heat exchange system which may be easily mounted to a container 100. The container 100 is filled with PCM so that at least one of the heat exchange coils 200 are at least partly in contact with the PCM (not shown). When manufacturing the system of FIG. 6, the heat exchange coils 200 may be connected to the headers 300, 301 simultaneously by melting or providing a melted or adhesive material to each end 280, 281 and thereafter fixing each coil 200 to their respective ports on the headers 300, 301. This provides a quick and efficient way of assembling the heat exchange system.

1. Thermal energy storage system comprising:
a container forming an inner volume;
a continuous heat exchange coil located inside the container, wherein the coil has been extruded throughout its length, the heat exchange coil configured to internally transport a coil fluid;
an inlet fixed to a wall of the container, the inlet being in fluid connection with the coil;
an outlet fixed to a wall of the container, the outlet being in fluid connection with the coil;
wherein the inner volume is at least partly filled with a phase change material surrounding at least a part of the coil;
wherein the extruded coil has a height of 1-4 mm and a width of 10-2000 mm and provides an upper surface and a lower surface each having the width and a length equal to a total length of the coil;
wherein the extruded coil comprises a profile and an array of internal channels for transporting the coil fluid;
and, as a result of the
internal channels, the profile obtains:
a thickness parameter above and below each internal channel to a perimeter of the coil profile, the thickness parameter providing a thermal conducting distance and rigidness to the coil; and
intermediate sections having a width and the height between the internal channels;
wherein, from a side-on point of view of the thermal energy storage system, the extruded coil is serpentine-shaped or S-shaped having:
at least two curved sections), wherein all of the curved sections have a radius of curvature;
the at least two curved sections turn 180 degrees forming at least three straight portions of the coil that run in parallel with a constant distance between each other.

2. Thermal energy storage system of claim 1, further comprising:
a first header extending along an axis and comprising the inlet;
a second header extending along an axis and comprising the outlet;
wherein the coil is connected at a first end to a respective port of the first header and at a second end to a respective port of the second header;
wherein each coil is in fluid communication with the first and second header;
wherein the first end of the coil extends longitudinally along the axis; and
wherein the second end of the coil extends longitudinally along the axis.

3. Thermal energy storage system of claim 1, comprising a plurality of coils wherein the coils have a distance between each other.

4. Thermal energy storage system of claim 2, comprising a plurality of coils wherein the coils have a distance between each other.

5. Thermal energy storage system according to claim 1,
wherein the inlet and the outlet are accessible outside the container; and
wherein the inlet and the outlet are connected to the same wall of the container, or wherein the inlet and the outlet are connected to separate walls of the container.

6. Thermal energy storage system according to claim 1, wherein each coil extends and runs along a horizontal plane of the container.

7. Thermal energy storage system according to claim 1, wherein each coil extends and runs along a vertical plane of the container.

8. Thermal energy storage system according to claim 1, wherein phase change material is one of, or a combination of water, hydrated salts, organic compounds, sugar-alcohol, paraffine, esters, high-density polyethylene, and eutectic mixtures.

9. Thermal energy storage system according to claim 1, wherein each internal channel has a round, elliptical, rectangular or square cross-section.

10. Thermal energy storage system according to claim 1, wherein each coil has a width to height ratio between 3:1 and 2000:1.

11. (canceled)

12. Thermal energy storage system according to claim 1, wherein the radius of curvature is 5-25 mm.

13. Thermal energy storage system according to claim 1, wherein each coil has a height to thickness ratio between 2:1 and 20:1.

14. Thermal energy storage system according to claim 1, wherein the ratio between a summarized cross-sectional area of the internal channels and a cross-sectional coil area and is between 1:4 and 4:1.

15. Thermal energy storage system to claim 1, wherein each coil is made of aluminium or an aluminium alloy.

16. Thermal energy storage system according to claim 1, wherein the coil fluid is a gas such as air, steam, CO₂, butane, propane, ammonia or a combination of the former.

17. Thermal energy storage system according to claim 1, wherein the coil fluid is a liquid such as water, glycol, CO₂, ammonia, butane, oil, propane or a combination of the former.

18. Thermal energy storage system according to claim 1, wherein at least one sensor is connected to an external surface along the width of the coil.

19. Method of manufacturing the heat exchange coil according to claim 1, by extrusion;
wherein the method comprises a step of bending the coil to form the plurality of curved sections.

20. Method of manufacturing the hollow heat exchange coil according to claim 19, wherein the coil is extruded in aluminium or an aluminium alloy.

21. Method of assembling the thermal energy storage system of claim 1, comprising the steps of:
providing at least one heat exchange coil;
placing at least one heat exchange coil at least partly within the container and submerging at least part of the heat exchange coil in phase change material;
bringing each heat exchange coil in fluid connection with a coil fluid inlet and a coil fluid outlet so that a coil fluid may run through each coil from the inlet to the outlet.

22. Method of assembling a thermal energy storage system according to claim 21, further comprising:
providing a first header and a second header;
connecting a first end of each coil to a respective port of the first header;
connecting a second end of each coil to a respective port of the second header;
wherein the coilsand the headers are pre-assembled as a separate assembly before it is placed within the container.
